(19) United States
(12) Patent Application Publication
(10) Pub. No.: US 2025/0356652 A1
(43) Pub. Date: Nov. 20, 2025

(54) SPATIOTEMPORAL STIMULI-AWARE VIDEO AFFECTIVE REASONING

(71) Applicant: Honda Motor Co., Ltd., Tokyo (JP)

(72) Inventors: Yuxiang GUO, Baltimore, MD (US); Shao-Yuan LO, Milpitas, CA (US); Kwonjoon LEE, Sunnyvale, CA (US); Faizan SIDDIQUI, Santa Clara, CA (US); Enna SACHDEVA, Santa Clara, CA (US)

(21) Appl. No.: 19/210,576

(22) Filed: May 16, 2025

Related U.S. Application Data
(60) Provisional application No. 63/649,143, filed on May 17, 2024.

(51) Int. Cl. G06V 20/40; G06V 10/774

(52) U.S. Cl. CPC G06V 20/41; G06V 10/774; G06V 20/44

(57) ABSTRACT

According to one aspect, spatiotemporal stimuli-aware video affective reasoning may include identifying one or more event-driven frames from a set of one or more frames of a training video based on an optical flow associated with one or more of the frames of the training video and training a projector based on the event-driven frames and an associated emotional response. The projector may receive an encoding of the event-driven frames and generate a visual token indicative of the event-driven frames based on the encoding of the event-driven frames.

### CROSS-REFERENCE TO RELATED APPLICATIONS

This application claims the benefit of U.S. Provisional Patent Application, Ser. No. 63/649,143 (Attorney Docket No. HRA-56057) entitled “SPATIOTEMPORAL STIMULI-AWARE VIDEO AFFECTIVE REASONING WITH MULTIMODEL LARGE LANGUAGE MODELS”, filed on May 17, 2024; the entirety of the above-noted application(s) is incorporated by reference herein.

### BACKGROUND

Understanding human emotional responses to videos may be useful for developing socially intelligent systems that enhance human-computer interaction, personalized services, and more. In recent years, user-generated videos on social media platforms have become an integral part of modern society. With increasing concerns about mental health, there is growing public attention on how videos affect viewers' well-being. Unlike most existing Video Emotion Analysis (VEA) approaches that focus on analyzing the emotions of characters in a video, predicting and reasoning about a video's emotional impact on viewers is a more challenging task. This challenge requires not only an understanding of video content but also common-sense knowledge of human reactions and emotions.

Predicting and reasoning how a video may make a human feel may be useful for developing socially intelligent systems. Although Multimodal Large Language Models (MLLMs) have shown impressive video understanding capabilities, LLMs tend to focus more on the semantic content of videos. Hence, most existing MLLMs fall short in estimating viewers' emotional reactions and providing plausible explanations.

### BRIEF DESCRIPTION

According to one aspect, a system for spatiotemporal stimuli-aware video affective reasoning may include a processor and a memory. The memory may store one or more instructions. The processor may execute one or more of the instructions stored on the memory to perform one or more acts, actions, and/or steps. The processor may identify one or more event-driven frames from a set of one or more frames of a training video based on an optical flow associated with one or more of the frames of the training video. The processor may train a projector based on the event-driven frames and an associated emotional response. The projector may receive an encoding of the event-driven frames and generate a visual token indicative of the event-driven frames based on the encoding of the event-driven frames.

The projector may be trained based on freezing a large language model (LLM) and a visual encoder. The encoding of the event-driven frames may be generated by a visual encoder based on the event-driven frames. The processor may train an emotion triggered tube selector based on the event-driven frames, the associated emotional response, and an associated emotional reasoning process. The associated emotional reasoning process may be generated by an artificial intelligence (AI) model. The emotion triggered tube selector may receive the visual token and identify a tube of spatiotemporal areas from the event-driven frames considered to trigger human emotion based on the visual token. The projector and the emotion triggered tube selector may be trained using two-phase affective training. The processor may train a low rank adaptation (LoRA) of a large language model (LLM) based on the event-driven frames, the associated emotional response, and an associated emotional reasoning process. The LoRA may receive the tube of spatiotemporal areas and generate a spatiotemporal stimuli-aware video affective reasoning associated with the training video based on the tube of spatiotemporal areas. The identifying the event-driven frames from the optical flow may include Gaussian filtering one or more of the frames of the training video.

According to one aspect, a system for spatiotemporal stimuli-aware video affective reasoning may include a processor and a memory. The memory may store one or more instructions. The processor may execute one or more of the instructions stored on the memory to perform one or more acts, actions, and/or steps. The processor may identify one or more event-driven frames from a set of one or more frames of a video based on an optical flow associated with one or more of the frames of the video. The processor may generate a visual token indicative of the event-driven frames based on an encoding of the event-driven frames and a projector.

The projector may be trained based on a training video and an associated emotional response. The system for spatiotemporal stimuli-aware video affective reasoning may include an emotion triggered tube selector identifying a tube of spatiotemporal areas from the event-driven frames considered to trigger human emotion based on the visual token. The system for spatiotemporal stimuli-aware video affective reasoning may include a low rank adaptation (LoRA) of a large language model (LLM) generating a spatiotemporal stimuli-aware video affective reasoning associated with the video based on the tube of spatiotemporal areas. The LoRA may be trained based on an emotional reasoning process generated by an artificial intelligence (AI) model.

According to one aspect, a computer-implemented method for spatiotemporal stimuli-aware video affective reasoning may include identifying one or more event-driven frames from a set of one or more frames of a training video based on an optical flow associated with one or more of the frames of the training video and training a projector based on the event-driven frames and an associated emotional response. The projector may receive an encoding of the event-driven frames and generate a visual token indicative of the event-driven frames based on the encoding of the event-driven frames.

The computer-implemented method for spatiotemporal stimuli-aware video affective reasoning may include training an emotion triggered tube selector based on the event-driven frames, the associated emotional response, and an associated emotional reasoning process. The emotion triggered tube selector may receive the visual token and identifies a tube of spatiotemporal areas from the event-driven frames considered to trigger human emotion based on the visual token. The computer-implemented method for spatiotemporal stimuli-aware video affective reasoning may include training a low rank adaptation (LoRA) of a large language model (LLM) based on the event-driven frames, the associated emotional response, and an associated emotional reasoning process. The LoRA may receive the tube of spatiotemporal areas and generate a spatiotemporal stimuli-aware video affective reasoning associated with the training video based on the tube of spatiotemporal areas.

### BRIEF DESCRIPTION OF THE DRAWINGS

FIG. 1 is an exemplary component diagram of a system for spatiotemporal stimuli-aware video affective reasoning, according to one aspect.

FIG. 2 is an exemplary illustration of a framework for the system for spatiotemporal stimuli-aware video affective reasoning of FIG. 1, according to one aspect.

FIG. 3 is an exemplary illustration of frames of a video associated with spatiotemporal stimuli-aware video affective reasoning, according to one aspect.

FIG. 4 is an exemplary flow diagram of a computer-implemented method for spatiotemporal stimuli-aware video affective reasoning, according to one aspect.

FIG. 5 is an illustration of an example computing environment where one or more of the provisions set forth herein are implemented, according to one aspect.

FIG. 6 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “robot”, as used herein, may be a machine, such as one programmable by a computer, and capable of carrying out a complex series of actions automatically. A robot may be guided by an external control device or the control may be embedded within a controller. It will be appreciated that a robot may be designed to perform a task with no regard to appearance. Therefore, a ‘robot’ may include a machine which does not necessarily resemble a human, including a vehicle, a device, a flying robot, a manipulator, a robotic arm, etc.

A “robot system”, as used herein, may be any automatic or manual systems that may be used to enhance robot performance. Exemplary robot systems include a motor system, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a suspension system, an audio system, a sensory system, among others.

Traditional emotion models are generally trained to map visual embeddings to corresponding emotion labels. These models heavily rely on basic visual attributes, such as color, brightness, or object class, which are often insufficient for accurately estimating viewers' emotional reactions. While recent advances in MLLMs have demonstrated superiority in various video understanding tasks, LLMs tend to focus more on the semantic content and factual analysis of videos. This lack of awareness of emotional knowledge often leads these MLLMs to fall short in viewer-centered Video Emotion Analysis (VEA).

On the other hand, interpretability is useful for earning public trust when deploying models in real-world applications. Still, traditional emotion models are not explainable, and most current MLLMs fail to provide plausible affective explanations due to their limited awareness of emotional stimuli, as previously discussed. Although a few recent efforts aim at explainable emotion analysis, others consider only image data or lack a comprehensive evaluation protocol to fully validate their reasoning ability. The task of reasoning human affective responses triggered by videos remains less explored.

In this regard, spatiotemporal stimuli-aware video affective reasoning may be provided via a spatiotemporal stimuli-aware framework for video affective reasoning (VAR) with a Multimodal Large Language Model (MLLM). For example, a system for spatiotemporal stimuli-aware video affective reasoning may incorporate a two-level stimuli-aware mechanism including frame-level awareness and token-level awareness. Frame-level awareness may include sampling video frames with events that are most likely to evoke viewers' emotions. Token-level awareness may be implemented by performing tube selection in a token space to make the MLLM concentrate on emotion-triggered spatiotemporal regions. A VAR instruction data set may be created to facilitate affective training, thereby steering the MLLMs' reasoning strengths towards emotional focus and enhancing their affective reasoning ability.

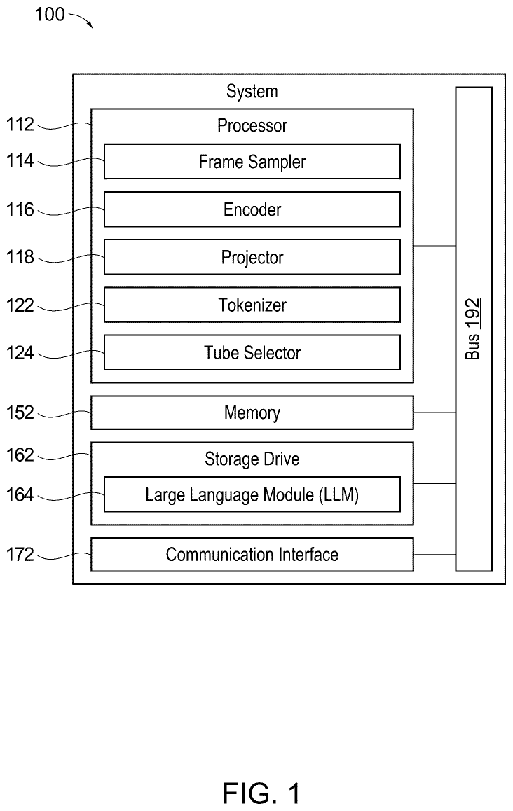

FIG. 1 is an exemplary component diagram of a system 100 for spatiotemporal stimuli-aware video affective reasoning, according to one aspect. The system 100 for spatiotemporal stimuli-aware video affective reasoning may include a processor 112. The processor 112 may include a frame sampler 114, an encoder 116, a projector 118, a tokenizer 122, and an emotion triggered tube selector 124. The system 100 for spatiotemporal stimuli-aware video affective reasoning may include a memory 152 and a storage drive 162. The storage drive 162 may store one or more models, such as a large language model (LLM), a projector 118 model, an encoder 116 model, a low rank adaptation (LoRA) of the LLM, or other models associated with spatiotemporal stimuli-aware video affective reasoning. The system 100 for spatiotemporal stimuli-aware video affective reasoning may include a communication interface 172. The communication interface 172 may receive information or data, such as a training video during a training phase or a video during an execution phase. The system 100 for spatiotemporal stimuli-aware video affective reasoning may include a bus 192. The bus 192 may operably connect one or more of the components of the system 100 for spatiotemporal stimuli-aware video affective reasoning. In this way, the processor 112, the memory 152, the storage drive 162, and the communication interface 172 may perform computer communication therebetween.

The system 100 for spatiotemporal stimuli-aware video affective reasoning may include a spatiotemporal stimuli-aware framework for Video Affective Reasoning (VAR) with Multimodal Large Language Models (MLLMs). The system 100 for spatiotemporal stimuli-aware video affective reasoning may incorporate a two-level stimuli-aware mechanism to identify spatiotemporal stimuli including frame-level awareness and token-level awareness. For frame-level awareness, event-driven frame sampling may be implemented using optical flow as a cue to capture the frames that contain unexpected events or unintentional accidents. These frames are likely to be the stimuli that evoke viewers' emotions. For token-level awareness, emotion-triggered tube selection may be implemented to localize the emotion-triggered spatiotemporal regions in the token space, which the MLLM may emphasize. In addition, a VAR visual instruction data set may be created via an AI model (e.g., GPT) to perform affective training. The VAR-specific instruction data may steer the MLLM's reasoning strengths and common-sense knowledge towards an emotional focus, thereby enhancing the MLLM's ability to provide insightful and contextually relevant explanations for its affective understanding. In this way, the system 100 for spatiotemporal stimuli-aware video affective reasoning may be a MLLM-based method for predicting and reasoning viewers' emotional reactions to videos.

The memory 152 may store one or more instructions. The processor 112 may execute one or more of the instructions stored on the memory 152 to perform one or more acts, actions, and/or steps.

### Training Phase

During the training phase, a training video may be provided via the communication interface 172.

### Training Phase—Event Driven Frame Sampling

The processor 112, via the frame sampler 114 may identify one or more event-driven frames from a set of one or more frames of a training video based on an optical flow associated with one or more of the frames of the training video.

The identifying the event-driven frames from the optical flow may include Gaussian filtering one or more of the frames of the training video.

### Training Phase—Encoder

An encoding of the event-driven frames may be generated by the processor 112, via the encoder 116 (e.g., a visual encoder), based on the event-driven frames.

### Two-Phase Affective Training

The projector 118 and the emotion triggered tube selector 124 may be trained using two-phase affective training.

### Training Phase—Projector

The processor 112 may train a projector 118 based on the event-driven frames and an associated emotional response. The projector 118 may receive an encoding of the event-driven frames and generate a visual token indicative of the event-driven frames based on the encoding of the event-driven frames. The projector 118 may be trained based on freezing a large language model (LLM) and a visual encoder.

### Training Phase—Emotion Triggered Tube Selector

The processor 112 may train an emotion triggered tube selector 124 based on the event-driven frames, the associated emotional response, and an associated emotional reasoning process. The associated emotional reasoning process may be generated by an artificial intelligence (AI) model. The emotion triggered tube selector 124 may receive the visual token and identify a tube of spatiotemporal areas from the event-driven frames considered to trigger human emotion based on the visual token.

### Training Phase—Low Rank Adaptation (LORA) of LLM

The processor 112 may train a low rank adaptation (LoRA) of a large language model (LLM) based on the event-driven frames, the associated emotional response, and an associated emotional reasoning process. The LoRA may receive the tube of spatiotemporal areas and generate a spatiotemporal stimuli-aware video affective reasoning associated with the training video based on the tube of spatiotemporal areas.

### Execution Phase

During the execution phase, a video (e.g., runtime video) may be provided via the communication interface 172.

### Execution Phase—Event Driven Frame Sampling

The processor 112 may identify one or more event-driven frames from a set of one or more frames of a video (e.g., the runtime video) based on an optical flow associated with one or more of the frames of the video.

### Execution Phase—Encoder

The processor 112, via the encoder 116 may generate the encoding of the event-driven frames based on the event-driven frames.

### Execution Phase—Projector

The processor 112, via the projector 118, may generate a visual token indicative of the event-driven frames based on the encoding of the event-driven frames and a projector 118. As discussed, the projector 118 may be trained based on the training video and the associated emotional response during the training phase.

### Execution Phase—Emotion Triggered Tube Selector

The trained emotion triggered tube selector 124 may identify a tube of spatiotemporal areas from the event-driven frames considered to trigger human emotion based on the visual token.

### Execution Phase—Low Rank Adaptation (LoRA) of LLM

The trained low rank adaptation (LoRA) of a large language model (LLM) may generate a spatiotemporal stimuli-aware video affective reasoning associated with the video based on the tube of spatiotemporal areas. As discussed, the LoRA may be trained based on the emotional reasoning process, as generated by the AI model. The communication interface 172 may include a display or one or more other output devices outputting or displaying the spatiotemporal stimuli-aware video affective reasoning and the output emotion. The output emotion may be generated by feeding the visual token and a tokenized prompt through the LLM or MLLM.

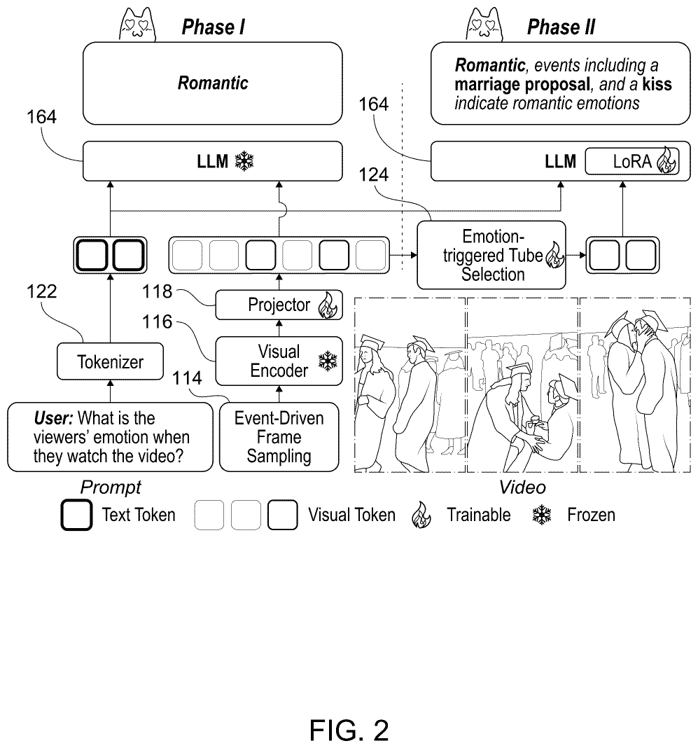

FIG. 2 is an exemplary illustration of a framework for the system 100 for spatiotemporal stimuli-aware video affective reasoning of FIG. 1, according to one aspect. The system 100 for spatiotemporal stimuli-aware video affective reasoning may include a spatiotemporal stimuli-aware framework for VAR based on the MLLM backbone. VAR may be a task aiming to predict viewers' emotional responses to a given video and provide reasoning for the prediction, and may be formulated as follows:

$$\{ E , R \} = ℱ ( V , P ) \qquad ( 1 )$$

where V is an input video, P is an input text prompt, E is the predicted emotion response, and R is free-form textual reasoning for the emotion prediction E. The processor 112 may employ an MLLM as a backbone of the VAR model [symbol] . An exemplary MLLM architecture utilized may include a visual encoder [symbol] , a projector 118 [symbol] , a tokenizer 122 [symbol] , and a LLM [symbol] , and thus Equation (1) may be written as:

$$\{ E , R \} = {ℱ}_{llm} ( {ℱ}_{proj} ( {ℱ}_{v} ( V ) ) , {ℱ}_{t} ( P ) ) \qquad ( 2 )$$

The system 100 for spatiotemporal stimuli-aware video affective reasoning may thus address the lack of interpretability in traditional emotion models and the lack of emotional stimuli awareness in other MLLMs.

### Spatiotemporal Stimuli Awareness

The system 100 for spatiotemporal stimuli-aware video affective reasoning may include two levels of awareness, such as frame-level awareness and token-level awareness. Frame-level awareness may be achieved through event-driven frame sampling, which includes sampling video frames that include events most likely to evoke viewers' emotions. Token-level awareness may be achieved via the emotion-triggered tube selection, which selects regions in the token space to guide the MLLM's focus toward emotion-triggered spatiotemporal areas.

### Event-Driven Frame Sampling

In video tasks, uniformly sampling frames may be performed to represent a video due to temporal redundancy. However, uniform sampling often fails to represent videos containing rapid, unexpected actions or unintentional accidents, most likely to evoke viewers' emotional reactions. This is because uniform sampling may miss the frames of such rapid but noteworthy events. While processing every frame without sampling may preserve the temporal information, the computational burden may be significant, especially for MLLMs. To achieve frame-level stimuli awareness, a sampling method is provided herein that selects the most representative frames within the same constrained number as the uniform sampling baseline. According to one aspect, frame sampling may meet the following criteria:
capture noteworthy events by identifying frames that depict the noteworthy events for affective understanding;
include a constrained or limited number of frames by selecting the most representative frames within an allotted frame budget; and
fast processing: perform sampling efficiently to ensure timely analysis.

The event-driven frame sampling may be based on the observation that rapid noteworthy events often coincide with dramatic changes in a video's appearance. These appearance changes may be modeled using optical flow estimation. For example, consider a video V including of frames {f₁, f₂, . . . f_{T}}; an optical flow estimator derives the pattern of apparent motion between each pair of adjacent frames fₜ and fₜ₊₁ as follows:

$${OF}_{t} = OpticalFlow ( {f}_{t} , {f}_{t + 1} ) for t = 1 , 2 , … , T - 1 , \qquad ( 3 )$$

where OFₜ is a frame-level optical flow value (e.g.,, mean absolute of each pixel's optical flow value), and then obtain a set of estimated optical flows {OF₁, OF₂, . . . . OF_{T-1}} of the video. The processor 112 may construct a curve OFₜ that depicts the intensity of the optical flows over time. To mitigate noise-induced fluctuations, the processor 112 may apply Gaussian smoothing to this curve using a Gaussian filter G_{σ:}

$$( t ) = ( OF * {G}_{σ} ) ( t ) = {\sum }_{t = - ∞}^{∞} OF ( t - τ ) {G}_{σ} ( τ ) \qquad ( 4 )$$

define the p highest peaks in the smoothed curve [symbol] (t) as the center of noteworthy events, e.g., { [symbol] ₑ₁, [symbol] ₑ₂, . . . , [symbol] ₑₚ}, where each e denotes a noteworthy event in the video. The peaks may be determined based on a predefined minimum distance between each other and prominence. The processor 112 may locate the corresponding frames {fₑ₁, fₑ₂, . . . , fₑₚ} of the p peaks, and each event is centered around its peak frame, spanning a duration of 2d frames as {f_{ei-d}, . . . , fₑᵢ, . . . , f_{ei+d}} for i=1,2, . . . , p. The processor 112 may designate the 2d+1 frames of each event as event-related frames, while the remaining T−p×(2d+1) non-event frames may be collectively treated as a single “event”.

Given the higher likelihood of important information within the event-related frames, the processor 112 may assign a high-intensity sampling rate to them, while the non-event frames are sampled with a low-intensity rate. Consider a predefined number of frames to sample as N, these N frames are evenly distributed across all “events” e={e₁, e₂, . . . , eₚ₊₁}, where regard non-event as a single “event”. In other words, the processor 112 may uniformly sample

$$\frac{N}{p + 1}$$

frames from each event set, and more frames are involved in the non-event set compared to the event set, thereby achieving varying sampling rates. This enables discriminative sampling based on event occurrence, ensuring an efficient allocation of resources to effectively capture the frames from the video.

### Emotion-Triggered Tube Selection

After sampling the informative frames that represent a video, the processor 112 may select the regions of interest in the MLLM's token space that are more likely to trigger human emotions, thereby achieving token-level stimuli awareness. This emotion-triggered tube selection module guides the MLLM's focus on the stimulus regions, enhances interpretability, and reduces tokens, leading to a decrease in computational cost.

Inspired by patch selection in visual recognition, the processor 112 may formulate token selection as a Top-K problem. As illustrated in FIG. 2, to identify emotional stimuli areas in the token space, the processor 112 may focus on the <Patch>tokens of the visual tokens after the projector 118, denoted as k∈ [symbol] ^{N×L×C}, where C is the embedding dimension and L is the number of tokens. The processor 112 may use a two-layer perceptron [symbol] to estimate correlation scores between each token and the output response, given by c= [symbol] (k)∈ [symbol] ^{N×L}. Next, the processor 112 may reshape the correlation scores c into a 3D volume c^{r}∈ [symbol] , according to the patch coordinates of the original input frames. This volume is split into tubes of shape t×h×w, resulting in

$$( ( \frac{N - t}{{d}_{t}} + 1 ) \times ( \frac{\sqrt{L} - h}{{d}_{h}} + 1 ) \times ( \frac{\sqrt{L} - w}{{d}_{w}} + 1 ) )$$

tubes, where (dₜ, d_{w}, dₕ) denotes the stride shape. The token scores within each tube are averaged to obtain each tube's score, and then select the Top-K tubes with the highest correlation scores as the final video representation sent to the following LLM.

This design for the system 100 for spatiotemporal stimuli-aware video affective reasoning differs from existing token selection approaches that consider the temporal and spatial domains sequentially. In other approaches, temporal selection may influence the final performance, especially after the frame sampling step. Missing frames that trigger emotions during the token selection process significantly reduces the chance of making a correct prediction. In contrast, the tube selection of the system 100 for spatiotemporal stimuli-aware video affective reasoning may group tokens into tubes, ensuring that the selection is driven by both temporal and spatial information. This provides the advantage and benefit of preserving each frame's intrinsic spatial structure and accounts for the entire video's consistency and continuity. Furthermore, the tube selection allows for efficient utilization of computational resources while identifying emotional stimuli in the video.

### Affective Training

To fully integrate the stimuli-aware mechanism into the MLLM backbone and to enhance the MLLM's affective reasoning ability, introduce an affective training protocol to fine-tune the MLLM. The affective training may include two phases. In the initial phase, train the projector 118 [symbol] with training video and emotional response label pairs {V, Y_{E}}, while keeping the pre-trained visual encoder 116 [symbol] and LLM [symbol] frozen, as follows:

$${min}_{{θ}_{{ℱ}_{proj}}} ℒ ( ℱ ( V , P ; {θ}_{{ℱ}_{v}} , {θ}_{{ℱ}_{proj}} , {θ}_{{ℱ}_{llm}} ) , {Y}_{E} ) \qquad ( 5 )$$

where [symbol] is the cross-entropy loss. This phase aligns the affective visual information with the LLM space and learns the correlation between videos and the emotions the videos trigger.

In the second phase, enhance the MLLM's ability to offer plausible reasoning for its emotional predictions through visual instruction tuning. To create VAR-specific visual instruction data, use the AI model to generate causal connections between videos and the emotions the videos trigger. Given most AI model's limitation in perceiving large-scale video data, first employ a vision-language model to produce captions for each sampled frame, ordering them in a format like “Frame 1 description: . . . ; Frame 2 description: . . . ”. The AI model may take temporal correlations into account to summarize these frame-level captions into a video-level caption. Compared to directly captioning videos in a single step using a video-oriented MLLM, this progressive summarization method captures video details and ensures frame-level temporal consistency, thereby mitigating hallucination.

Next, the AI model may be prompted to generate a reasoning process of deriving the label from an input. Specifically, given the pairs of the video caption <Video Caption> (i.e., the caption of V) and the emotional response label <Emotion> (i.e., Y_{E}), query the AI model to explain viewers' emotional responses when viewers watch the videos.

The output reasoning process may be denoted as Y_{R}. The processor 112 may use the VAR instruction data {V, Y_{E}, Y_{R}} to train the emotion-triggered tube module θ_{tube} and fine-tune the projector 118 and LLM by LoRA as follows:

$${min}_{{θ}_{tune}} ℒ ( ℱ ( V , P ; {θ}_{{ℱ}_{v}} , {θ}_{{ℱ}_{proj}} , {θ}_{tube} , {θ}_{{ℱ}_{llm}} ) , \{ {Y}_{E} , {Y}_{R} \} ) , \\ {θ}_{tune} = \{ {θ}_{{ℱ}_{proj}} , {θ}_{tube} , {θ}_{{ℱ}_{llm}}^{lora} \} , \qquad ( 6 )$$

where [symbol] is the cross-entropy loss. This phase fosters the correspondence between visual tokens and output text, enhancing the MLLM's affective reasoning ability. The affective training protocol directs the MLLM's reasoning strengths and commonsense knowledge towards an emotional focus, enabling the MLLM to offer plausible explanations for its affective understanding.

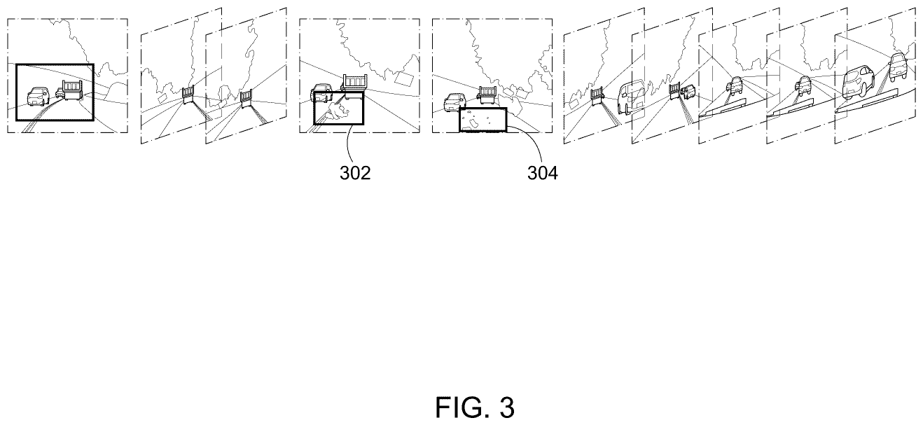

FIG. 3 is an exemplary illustration of frames of a video associated with spatiotemporal stimuli-aware video affective reasoning, according to one aspect. Unlike other methods which uniformly sample video frames, spatiotemporal stimuli-aware video affective reasoning may utilize event-driven sampling to achieve frame-level awareness and token-level awareness. Thus, the advantage or benefit of detecting rapid yet noteworthy events that are most likely to evoke viewers' emotions may be provided by the event-driven sampling.

Psychologists have highlighted that emotions are often triggered by specific elements, referred to as emotional stimuli. FIG. 3 illustrates such an example. For example, a dashcam video in which a rock suddenly falls onto the road within a few seconds, while the remaining frames depict regular driving scenes. Although most of the video depicts ordinary scenes, the unexpected rock fall may evoke surprise and/or fear in viewers. In this example, the falling rock may be considered a stimulus that predominantly shapes the viewers' emotional responses. However, a MLLM may overlook or not prioritize these emotional stimuli. From a temporal perspective, most MLLMs use uniform temporal down-sampling to sample input video frames. While uniform sampling may work well for general video understanding tasks, uniform sampling may miss an unexpected moments or rapid events that may generate strong reactions and thus make an inaccurate prediction. From a spatial perspective, emotional stimuli like the falling rock may occupy only a small region of the frame. Identifying these stimulus regions is useful for reducing redundant information and achieving more precise affective understanding.

With respect to example of FIG. 3, the system for spatiotemporal stimuli-aware video affective reasoning may implement event-driven frame sampling, efficiently selecting the frames containing rapid noteworthy events, such as a rock falling onto the road. Next, emotion-triggered tube selection may identify the areas 302, 304 where these events occur, represented by boxed regions, guiding MLLM's focus on these emotional stimuli. The system for spatiotemporal stimuli-aware video affective reasoning performs affective reasoning, which may offer rationales behind its predictions. For example, the system for spatiotemporal stimuli-aware video affective reasoning may recognize that the unexpected occurrence of a falling rock triggers the emotion of “surprise”.

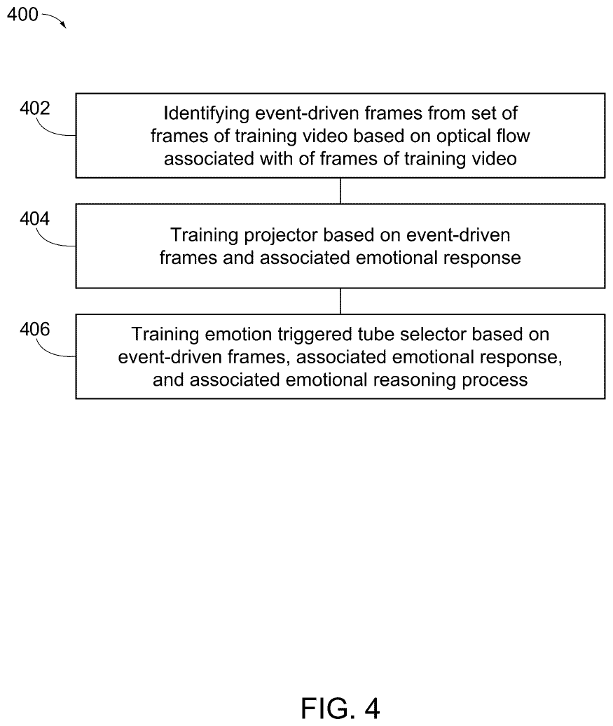

FIG. 4 is an exemplary flow diagram of a computer-implemented method 400 for spatiotemporal stimuli-aware video affective reasoning, according to one aspect. The computer-implemented method 400 for spatiotemporal stimuli-aware video affective reasoning may include identifying 402 one or more event-driven frames from a set of one or more frames of a training video based on an optical flow associated with one or more of the frames of the training video and training 404 a projector based on the event-driven frames and an associated emotional response. The projector may receive an encoding of the event-driven frames and generate a visual token indicative of the event-driven frames based on the encoding of the event-driven frames.

The computer-implemented method 400 for spatiotemporal stimuli-aware video affective reasoning may include training 406 an emotion triggered tube selector based on the event-driven frames, the associated emotional response, and an associated emotional reasoning process. The emotion triggered tube selector may receive the visual token and identifies a tube of spatiotemporal areas from the event-driven frames considered to trigger human emotion based on the visual token.

The computer-implemented method 400 for spatiotemporal stimuli-aware video affective reasoning may include training a low rank adaptation (LoRA) of a large language model (LLM) based on the event-driven frames, the associated emotional response, and an associated emotional reasoning process. The LoRA may receive the tube of spatiotemporal areas and generate a spatiotemporal stimuli-aware video affective reasoning associated with the training video based on the tube of spatiotemporal areas.

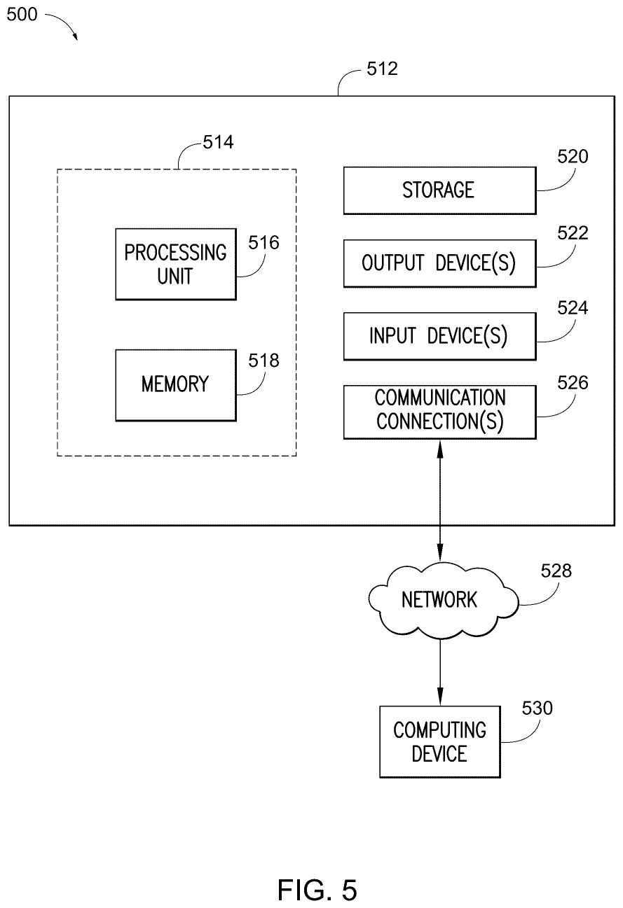

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, which perform one or more tasks or implement one or more abstract data types. Typically, the functionality of the computer readable instructions are combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by the at least one processing unit 516, for example.

The term “computer readable media” as used herein includes computer storage media. Computer storage media includes volatile and nonvolatile, removable, and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

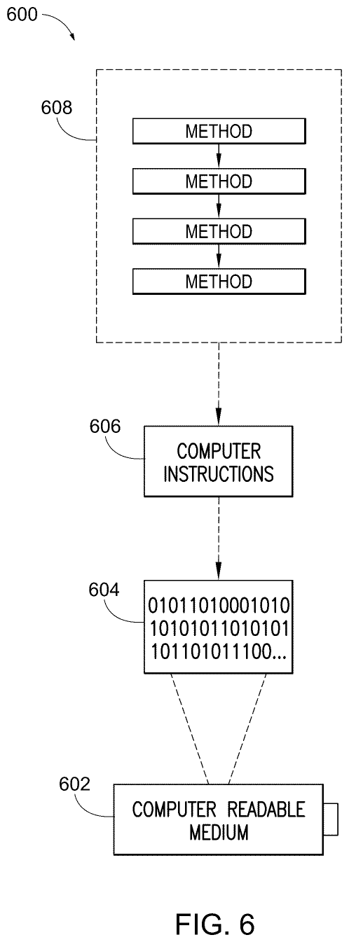

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 602, such as a CD-R, DVD-R, flash drive, a platter of a hard disk drive, etc., on which is encoded computer-readable data 604. This encoded computer-readable data 604, such as binary data including a plurality of zero's and one's as shown in 604, in turn includes a set of processor-executable computer instructions 606 configured to operate according to one or more of the principles set forth herein. In this implementation 600, the processor-executable computer instructions 606 may be configured to perform a method 608, such as the computer-implemented method 400 for spatiotemporal stimuli-aware video affective reasoning of FIG. 4. In another aspect, the processor-executable computer instructions 606 may be configured to implement a system, such as the system 100 for spatiotemporal stimuli-aware video affective reasoning of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for spatiotemporal stimuli-aware video affective reasoning, comprising:
a memory storing one or more instructions; and
a processor executing one or more of the instructions stored on the memory to perform:
identifying one or more event-driven frames from a set of one or more frames of a training video based on an optical flow associated with one or more of the frames of the training video; and
training a projector based on the event-driven frames and an associated emotional response, wherein the projector receives an encoding of the event-driven frames and generates a visual token indicative of the event-driven frames based on the encoding of the event-driven frames.

2. The system for spatiotemporal stimuli-aware video affective reasoning of claim 1, wherein the processor trains an emotion triggered tube selector based on the event-driven frames, the associated emotional response, and an associated emotional reasoning process.

3. The system for spatiotemporal stimuli-aware video affective reasoning of claim 2, wherein the emotion triggered tube selector receives the visual token and identifies a tube of spatiotemporal areas from the event-driven frames considered to trigger human emotion based on the visual token.

4. The system for spatiotemporal stimuli-aware video affective reasoning of claim 3, wherein the processor trains a low rank adaptation (LoRA) of a large language model (LLM) based on the event-driven frames, the associated emotional response, and an associated emotional reasoning process.

5. The system for spatiotemporal stimuli-aware video affective reasoning of claim 4, wherein the LoRA receives the tube of spatiotemporal areas and generates a spatiotemporal stimuli-aware video affective reasoning associated with the training video based on the tube of spatiotemporal areas.

6. The system for spatiotemporal stimuli-aware video affective reasoning of claim 4, wherein the associated emotional reasoning process is generated by an artificial intelligence (AI) model.

7. The system for spatiotemporal stimuli-aware video affective reasoning of claim 1, wherein training the projector is based on freezing a large language model (LLM) and a visual encoder.

8. The system for spatiotemporal stimuli-aware video affective reasoning of claim 1, wherein the encoding of the event-driven frames is generated by a visual encoder based on the event-driven frames.

9. The system for spatiotemporal stimuli-aware video affective reasoning of claim 2, wherein the projector and the emotion triggered tube selector are trained using two-phase affective training.

10. The system for spatiotemporal stimuli-aware video affective reasoning of claim 1, wherein the identifying the event-driven frames from the optical flow includes Gaussian filtering one or more of the frames of the training video.

11. A system for spatiotemporal stimuli-aware video affective reasoning, comprising:
a memory storing one or more instructions;
a processor executing one or more of the instructions stored on the memory to perform:
identifying one or more event-driven frames from a set of one or more frames of a video based on an optical flow associated with one or more of the frames of the video; and
generating a visual token indicative of the event-driven frames based on an encoding of the event-driven frames and a projector.

12. The system for spatiotemporal stimuli-aware video affective reasoning of claim 11, comprising an emotion triggered tube selector identifying a tube of spatiotemporal areas from the event-driven frames considered to trigger human emotion based on the visual token.

13. The system for spatiotemporal stimuli-aware video affective reasoning of claim 12, comprising a low rank adaptation (LoRA) of a large language model (LLM) generating a spatiotemporal stimuli-aware video affective reasoning associated with the video based on the tube of spatiotemporal areas.

14. The system for spatiotemporal stimuli-aware video affective reasoning of claim 13, wherein the LoRA is trained based on an emotional reasoning process generated by an artificial intelligence (AI) model.

15. The system for spatiotemporal stimuli-aware video affective reasoning of claim 11, wherein the projector is trained based on a training video and an associated emotional response.

16. A computer-implemented method for spatiotemporal stimuli-aware video affective reasoning, comprising:
identifying one or more event-driven frames from a set of one or more frames of a training video based on an optical flow associated with one or more of the frames of the training video; and
training a projector based on the event-driven frames and an associated emotional response, wherein the projector receives an encoding of the event-driven frames and generates a visual token indicative of the event-driven frames based on the encoding of the event-driven frames.

17. The computer-implemented method for spatiotemporal stimuli-aware video affective reasoning of claim 16, comprising training an emotion triggered tube selector based on the event-driven frames, the associated emotional response, and an associated emotional reasoning process.

18. The computer-implemented method for spatiotemporal stimuli-aware video affective reasoning of claim 17, wherein the emotion triggered tube selector receives the visual token and identifies a tube of spatiotemporal areas from the event-driven frames considered to trigger human emotion based on the visual token.

19. The computer-implemented method for spatiotemporal stimuli-aware video affective reasoning of claim 18, comprising training a low rank adaptation (LoRA) of a large language model (LLM) based on the event-driven frames, the associated emotional response, and an associated emotional reasoning process.

20. The computer-implemented method for spatiotemporal stimuli-aware video affective reasoning of claim 19, wherein the LoRA receives the tube of spatiotemporal areas and generates a spatiotemporal stimuli-aware video affective reasoning associated with the training video based on the tube of spatiotemporal areas.
